(19) United States
(12) Patent Application Publication
(10) Pub. No.: US 2022/0295235 A1
(43) Pub. Date: Sep. 15, 2022

(54) METHODS AND APPARATUS OF CONCURRENT TRANSMISSION OF MULTICAST BROADCAST SERVICE

(71) Applicant: MediaTek Singapore Pte. Ltd., Singapore (SG)

(72) Inventor: Xuelong Wang, Beijing (CN)

(21) Appl. No.: 17/710,960

(22) Filed: Mar. 31, 2022

Related U.S. Application Data
(63) Continuation of application No. PCT/CN2021/080473, filed on Mar. 12, 2021.

(30) Foreign Application Priority Data
Mar. 2, 2022 (CN) 202210201807.6

(51) Int. Cl. H04W 4/06; H04W 28/02; H04L 1/00

(52) U.S. Cl. CPC H04W 4/06; H04W 28/0268; H04W 28/0273; H04L 1/0008; H04W 80/02

(57) ABSTRACT

Apparatus and methods are provided for concurrent transmission of multicast broadcast service. In one novel aspect, the UE receives superposition information indicating superposition-based transmission for multiple downlink (DL) packet streams, decodes the received multiple DL packet streams based on the superposition information, identifies the DL packet streams at the MAC layer with corresponding MAC PDUs, and delivers the decoded MAC PDUs for each corresponding DL packet stream to upper layers of the UE. In another novel aspect, the base station receives superposition information from a core network, performs a joint alignment for MAC PDUs among each corresponding DL data packet stream at a MAC layer of the base station, encodes each DL packet stream independently at a physical (PHY) layer with independent encoding parameters, and transmits simultaneously the plurality of DL data packet streams on different corresponding RBs to UEs.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/080473, titled “Methods and apparatus of Concurrent Transmission of Multicast Broadcast Service,” with an international filing date of Mar. 12, 2021. This application claims priority under 35 U.S.C. § 119 from Chinese Application Number CN202210201807.6 titled “Methods and apparatus of Concurrent Transmission of Multicast Broadcast Service,” filed on Mar. 2, 2022. The disclosure of each of the foregoing documents is incorporated herein by reference.

### TECHNICAL FIELD

The disclosed embodiments relate generally to wireless communication, and, more particularly, to reliable concurrent transmission of multicast and broadcast service.

### BACKGROUND

With the rapid development of mobile communication system, the demand of multicast broadcast service (MBS) is emerging, e.g., popular media content, live stream, video distribution, vehicle-to-everything (V2X) communication, public safety (PS) communication and so on. In these cases, gNB can send a multicast or broadcast services to very larger number of UEs consuming the same data, which can decrease the physical downlink control channel signalling overhead to some extent. However, the legacy cellular multicast broadcast services only focus on the orthogonal frequency resource to transmit multiple multicast broadcast services or/and unicast, e.g., time domain multiplexing (TDM) or frequency domain multiplexing (FDM). When there are multiple multicast broadcast services, it requires one by one sequential DL transmission.

Considering the variety of multicast broadcast services and limited spectrum resource, the sequential transmission of multiple services or one service with different service quality is inefficient. In traditional cellular system, UE will report the channel information state (CSI) to gNB, and the upper layer will determine reasonable transport block size which can be carried by physical layer. Then, the radio link control (RLC) layer will transmit corresponding service segmentation parts to MAC layer and padding will be added if the RLC service contents are not enough to assemble a MAC packet data unit (PDU). For emerging multicast broadcast services, it will have more bits to be transmitted at upper layer, especially the high-quality service. If legacy method as mentioned above is used to deliver the data packet from the RLC layer to MAC layer, it can cause the services congestion and increase the services latency.

Improvements and enhancements are required to improve efficiency of MBS, which is limited by the sequential transmission for the wireless network.

### SUMMARY

Apparatus and methods are provided for concurrent transmission of multicast broadcast service. In one novel aspect, the user equipment (UE) receives superposition information indicating superposition-based transmission for multiple downlink (DL) packet streams, decodes the received multiple DL packet streams based on the superposition information, identifies the DL packet streams at the MAC layer with corresponding MAC PDUs, and delivers the decoded MAC PDUs for each corresponding DL packet stream to upper layers of the UE. In one embodiment, the superposition information is received from a RRCReconfiguration message, a MAC control element (CE), or a layer-1 (L1) signaling. In another embodiment, the UE combines different QoS data packet streams at a service data adaptation protocol (SDAP) layer. In yet another embodiment, the superposition information further comprises a MAC padding indication to inform the UE of an amount of MAC padding bits for corresponding DL packet stream.

In another novel aspect, the base station receives superposition information from a core network, performs a joint alignment for MAC PDUs among each corresponding DL packet stream at a MAC layer of the base station, encodes each DL packet stream independently at a physical (PHY) layer with independent encoding parameters, and transmits simultaneously the plurality of DL data packet streams on different corresponding RBs to UEs. In one embodiment, each DL packet stream includes corresponding superposition information indicating the DL packet stream is subject to superposition transmission and its associated DL data packet. In another embodiment, the superposition information is received by the base station with association information of all the DL data packets for superposition transmission. In one embodiment, the base station allocates independent RBs for each DL packet stream SDAP layer. In another embodiment, the join alignment involves MAC padding and/or segmentation. In yet another embodiment, the joint alignment is based on modulation and coding scheme (MCS) factors for each packet data stream, desired TB size for each packet data stream, and transmission interval that carries the data packet streams.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports concurrent transmission of MBS.

FIG. 2A illustrates an exemplary NR wireless system with centralized upper layers of the NR radio interface stacks.

FIG. 2B illustrates exemplary diagrams for top-level procedure for the concurrent transmission of MBSs.

FIG. 3A illustrates an exemplary diagram of two independent packet streams that are created for two independent layers and combined for concurrent transmission.

FIG. 3B illustrates an exemplary diagram of one MBS with different QoS packet streams that are combined for concurrent transmission.

FIG. 3C illustrates an exemplary diagram of one or more different MBSs with optional unicast services are combined for concurrent transmission.

FIG. 4 illustrates exemplary diagrams of the protocol stack to allocate and process multiple independent MBS RBs with corresponding protocol stack entities to support the concurrent MBSs transmission.

FIG. 5 illustrates an exemplary flow chart of UE for the concurrent transmission of multiple packet streams for MBSs.

FIG. 6 illustrates an exemplary flow chart of base station for the concurrent transmission of multiple packet streams for MBSs.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system,

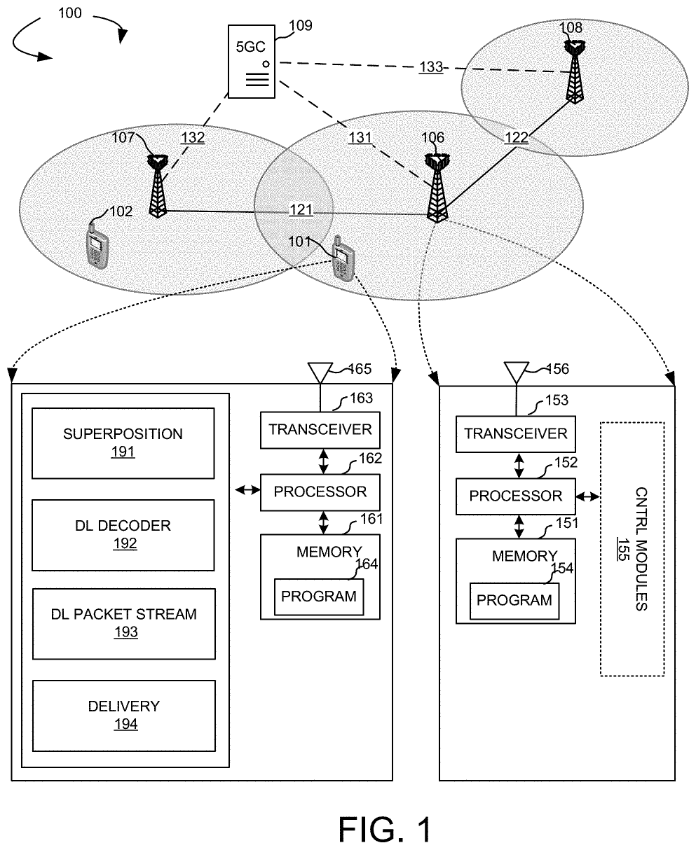

FIG. 1 is a schematic system diagram illustrating an exemplary wireless network that supports concurrent transmission of MBS. Aspects of the present disclosure provide methods, apparatus, processing systems, and computer readable mediums for NR (new radio access technology, or 5G technology) or other radio access technology. NR may support various wireless communication services. These services may have different quality of service (QoS) requirements, e.g., latency requirements, connected density and reliability requirements. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 106, gNB 107 and gNB 108 are base stations in the wireless network, the serving area of which may or may not overlap with each other. As an example, user equipment (UE) 101 or mobile station 101 is in the serving area covered by gNB 106 and gNB 107. As an example, UE 101 or mobile station 101 is only in the service area of gNB 106 and connected with gNB 106. UE 102 or mobile station 102 is only in the service area of gNB 107 and connected with gNB 107. gNB 106 is connected with gNB 107 via Xn interface 121. gNB 106 is connected with gNB 108 via Xn interface 122. A 5G network entity 109 connects with gNB 106, 107, and 108 via NG connection 131, 132, and 133, respectively. In one embodiment, gNB 106 and gNB 107 provide the same MBS. The service continuity during handover is guaranteed when UE 101 moves from gNB 106 to gNB 107 and vice versa. The area covered by gNB 106 and 107 with the same MBS is a multi-cast service area for the MBS.

In one novel aspect, the core network 109 indicates the correspondence of two or more MBS sessions or multiple QoS flows of the same MBS session that are subject to superposition-based transmission at physical layer. Subsequently, gNB 106 allocates independent radio bearers (RBs) to carry the data packet streams from such QoS flows or MBS sessions. From the scheduling perspective, the gNB ensures the bit alignment at MAC layer between the plurality of data packets streams before the physical (PHY) layer transmission in terms of MAC layer padding. In another novel aspect, the UE, such as UE 101 and/or UE 102, receives data packet streams from multiple encoding layers. The UE combines the multiple data packet streams and offers a combined view to the user. The UE removes the MAC padding from reception perspective before delivering the data to radio link control (RLC) layer. The service data adaptation protocol (SDAP) entity of the UE combines the two different QoS flows before submit the data to upper layer.

FIG. 1 further illustrates simplified block diagrams of a base station and a mobile device/UE for MBS transmission. gNB 106 has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 106. Memory 151 stores program instructions and data 154 to control the operations of gNB 106. gNB 106 also includes a set of control modules 155 that carry out functional tasks to communicate with mobile stations. These control modules can be implemented by circuits, software, firmware, or a combination of them.

FIG. 1 also includes simplified block diagrams of a UE, such as UE 101. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver 163 may comprise two RF modules (not shown) which are used for different frequency bands transmitting and receiving. RF transceiver 163 also converts received baseband signals from processor 162, converts them to RF signals, and sends out to antenna 165. Processor 162 processes the received baseband signals and invokes different functional modules to perform features in UE 101. Memory 161 stores program instructions and data 164 to control the operations of UE 101. Antenna 165 sends uplink transmission and receives downlink transmissions to/from antenna 156 of gNB 106.

The UE also includes a set of control modules that carry out functional tasks. These control modules can be implemented by circuits, software, firmware, or a combination of them. A superposition module 191 receives superposition information indicating superposition-based transmission for one or more multicast and broadcast services (MBSs), wherein a plurality of superposition-based downlink (DL) packet streams are received on one radio frequency (RF) channel from a base station, and wherein each DL packet stream corresponding to one MBS with its corresponding quality of service (QoS) is independently encoded. A DL decoder 192 decodes received plurality of DL packet streams for the one or more MBSs based on the superposition information. A DL packet stream module 193 identifies a plurality of DL packet streams at a MAC layer of the UE with corresponding decoded MAC packet data units (PDUs) for each DL packet stream. A delivery module 194 delivers decoded MAC PDUs for each corresponding DL packet stream to upper layers of the UE.

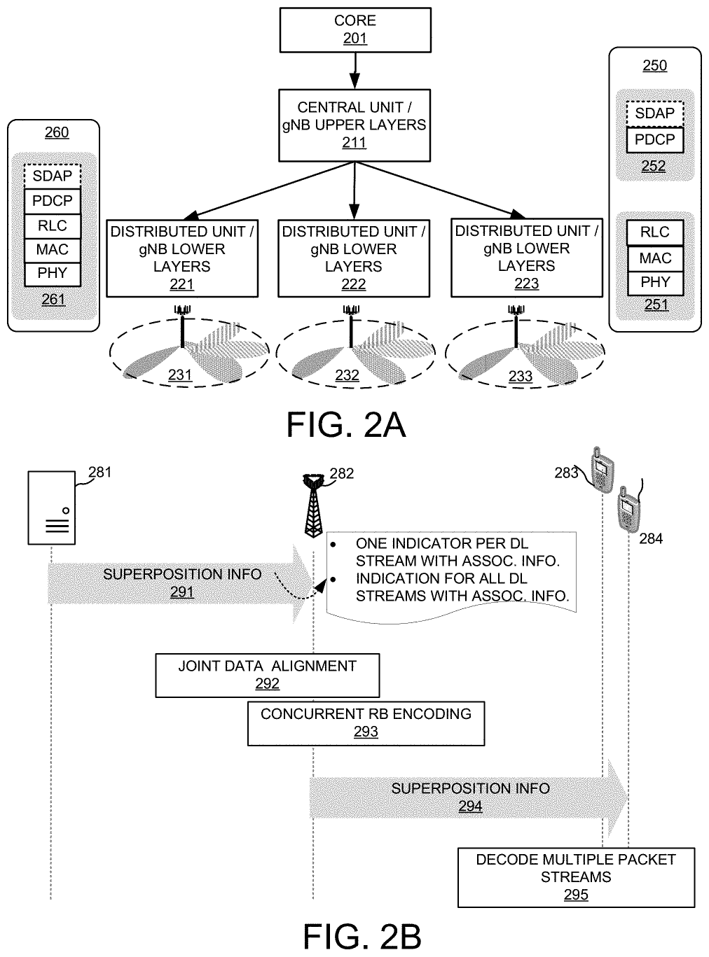

FIG. 2A illustrates an exemplary NR wireless system with centralized upper layers of the NR radio interface stacks. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261 including SDAP, PDCP, RLC, MAC and PHY layers.

FIG. 2B illustrates exemplary diagrams for top-level procedure for the concurrent transmission of MBSs. In certain systems, such as NR systems, NR MBS is transmitted in the coverage of a cell. From network perspective, the base station/gNB provides the information of a list of NR multicast/broadcast services with ongoing sessions transmitted on MBS logical channels e.g., MTCH(s). At physical layer, the data from the MBS logical channel is scheduled by gNB. UE decodes the MBS data according to its reception of the MBS logical channel. In an example, a core network entity 281 established connection with base stations, such as base station 282 over N2 interfaces. Base station 282 transmits data packets for UEs, such as UE 283 and UE 284 through air interface. In one novel aspect, concurrent MBS transmission is enabled for the wireless network to improve the spectrum utilization efficiency. The independent multi-layered encoding is used. Superimposed multiple packet streams are transmitted with the same RF channel. The network needs to communicate the configuration among the core network, such as the network entity 281, the base stations, such as base station 282, and UEs, such as UE 283 and UE 284.

At step 291, the core network, through the exemplary network entity 281, sends the superposition information for one or more MBSs. The superposition information indicates that concurrent transmission of multiple packet stream is used for one or more MBSs. Each of the one or more multiple packet streams is for an MBS session with a predefined quality of service (QoS), such as a QoS flow for a high density (HD) stream and another QoS flow for an ultra-HD (UHD) QoS flow for the same MBS. Other examples would be a right view video stream with HD QoS and a left view video stream for a UHD QoS for the same MBS. The multiple packet streams can be for one MBS with different QoS or for multiple MBSs. The superposition information from the core network may include MBS related information and/or UE information. MBS related information includes MBS session context ID, MBS group identity, and/or MBS flow information such as MBS QoS Flow ID(s) and associating QoS information. In one embodiment, each DL packet stream includes corresponding superposition information indicating the DL packet stream is subject to superposition transmission and its associated DL data packet. One indicator can be introduced within the MBS flow information to indicate which QoS flow can be subject to superposition transmission with which QoS flow at physical layer (e.g., QoS flow-X and flow-Y can be subject to superposition transmission at physical layer). In another embodiment, the superposition information is sent to the base station with association information of all the DL data packets for superposition transmission. One indicator can be introduced to express the association between two MBS sessions or among multiple MBS sessions to indicate which MBS session can be subject to superposition transmission at physical layer with which MBS session in case different MBS sessions are used to transmit the right view and left view of a single MBS service.

The superposition information indicates to the gNB 282 to perform corresponding handling at high layer protocol stack (i.e., SDAP/PDCP/RLC and MAC) and layer-based transmission at physical layer. Base station/gNB 282 performs concurrent transmission of the plurality of packet streams based on the superposition information received from the network. At step 292, base station/gNB 282 performs joint data alignment for the multiple data packet streams. At step 293, base station/gNB 282 performs concurrent RB encoding for the multiple data packet streams. At step 294, base station/gNB 282 sends superposition information to UEs, such as UE 283 and UE 284. The superposition information helps the UEs to associate the corresponding packet streams. In one embodiment, the superposition information is sent to the UEs using a RRCReconfiguration message or a MAC control element (CE), or a layer-1 (L1) signaling.

UEs, such as UE 283, receives packet streams from multiple layers. At step 295, UE 283 combines/decodes the multiple packet streams and offers a combined view to the user. UE needs to remove the MAC padding before delivering the data to RLC layer. A MAC padding indication (e.g., configured in the superposition information) should be used by the network to indicate to the UE the amount of the MAC padding bits. The location of the padding bits should be fixed e.g., at the rear of the MAC PDU. From the UE reception perspective, its SDAP entity needs to combine the two different QoS flows before submitting the data to upper layer. In order to direct the UE to do so, network can indicate such correspondence via a field within SDAP packet, or via control PDU, or via RRC message.

To enable flexible usage of the limited spectrum for MBS services, from physical layer perspective, two or multiple packet streams can be combined and coded together before actual OFDM modulation and its transmission over a single RF channel. The following diagrams illustrates different exemplary scenarios.

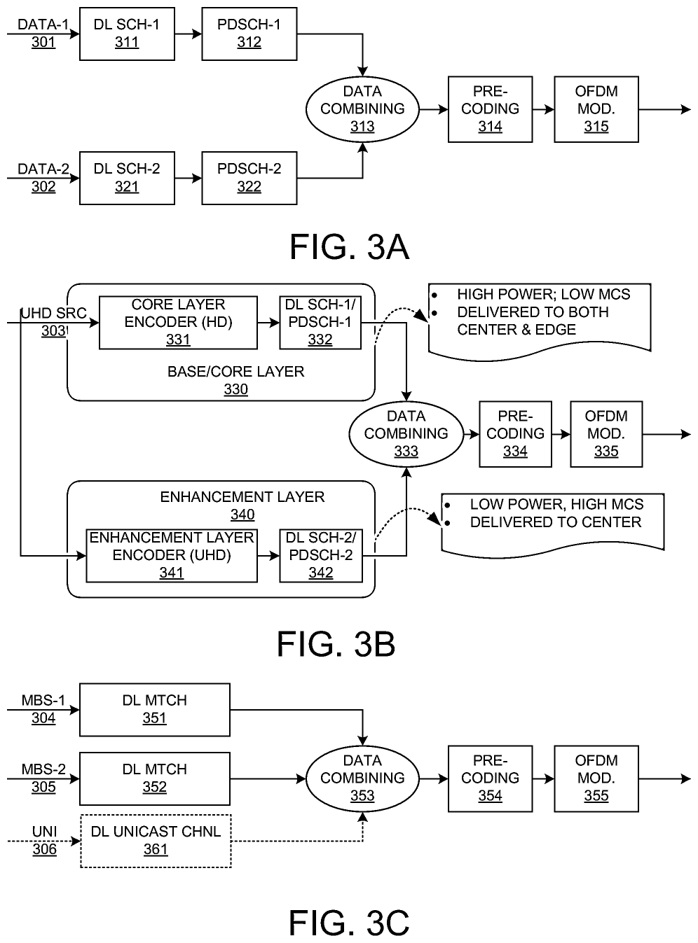

FIG. 3A illustrates an exemplary diagram of two independent packet streams that are created for two independent layers and combined for concurrent transmission. Two independent data flows data-1 301 and data-2 302 are created, one per each layer. A downlink (DL) Shared Channel (DL-SCH) transport channel is generated for each layer, DL SCH-1 311 for data-1 301 and DL SCH-2 321 for data-2 302. The DL-SCH is encapsulated into PDSCH where the modulation and the coding is applied. DL SCH-1 is encapsulated to PDSCH-1 312, and DL SCH-2 321 is encapsulated to PDSCH-2 322. The coding size is adapted depending on the modulation and code rate that is used for corresponding layer. Once PDSCH are generated for both layers, at step 313, they are combined into a single non-orthogonal multiple access (NOMA) signal ensemble. After superimposing both layers, the output constellation is normalized. At step 314, the precoding matrix for the next transmission is calculated using singular value decomposition. Then, at step 315, the OFDM signal is generated. In a typical implementation, these two packet streams over two layers are subject to superposition with different transmission power.

FIG. 3B illustrates an exemplary diagram of one MBS with different QoS packet streams that are combined for concurrent transmission. In an exemplary application of the concurrent transmission of MBSs, different QoS packet streams, such as UHD video and HD video, are superimposed and transmitted concurrently for one MBS. An UHD source 303 creates an UHD and HD simulcast broadcast delivery. The left view and the right view of a stereoscopic 3D video component can be a UHD video 331 and a HD video 341, respectively. There is no dependency between two views as two views are coded independently and decoded independently. That is, a receiver with normal channel quality can acquire HD right view video data from a physical channel and offers a HD service to the user. Another receiver with better channel quality can acquire UHD video data from a different physical channel and offers a UHD service to the user. Moreover, when a receiver can get data from two physical channels simultaneously, the receiver acquires an UHD left view 331 and a HD right view video 331 simultaneously and provides a 3D service by combining two views to the user. The different layered packet streams are combined at step 333. At step 334, precoding is performed. At step 335, the OFDM signal is generated.

By using layered-based concurrent transmission, such as with the coding scheme of high efficiency video coding (HEVC), the HD right view can be coded in a base layer and the UHD left view can be coded through enhancement layer. For example, DL SCH-1/PDSCH-1 332 is used to transmit the base/core layer 330 and DL SCH-2/PDSCH-2 342 is used to deliver the enhancement layer 340. The DL SCH-1/PDSCH-1 (i.e., the base/core layer 330) is transmitted with high power and low-level modulation (e.g., QPSK) and coding scheme, which can be received by the UEs at both cell center and cell edge. The DL SCH-2/PDSCH-2 (i.e., the enhancement layer 340) is transmitted with low power and high-level modulation (e.g., 1024QAM) and coding scheme, which can be only received by the UEs at cell center, as the UEs at cell center have better radio signal quality. In this example, the cell edge users can receive the HD right view of the MBS service. The cell center receiver needs to acquire the 3D UHD view by using both the base and the enhancement layers from two physical channels and the receiver displays 3D service by combining two views. One video stream, or one MBS session, can be coded by two different encoders that produce different packet streams (i.e. right view stream and left view stream). When the parallel coding streams are transmitted via different physical channels subject to superposition transmission, synchronized transmission is required at the transmitter side to ensure the presentation of the picture for an instant sample of a particular video stream at the receiver side. The coding streams are produced at information source by application layer via specific codec. They will go across high layer protocol stack PDCP/RLC/MAC before its transmission over the channel at physical layer.

FIG. 3C illustrates an exemplary diagram of one or more different MBSs with optional unicast services are combined for concurrent transmission. In one embodiment, one or more different MBSs with optional unicast service data packet streams are concurrent transmitted with layer-based concurrent transmission. MBS-1 304 uses multicast channel (MTCH) 351. MBS-2 305 uses multicast channel 352. Two different MBSs, MBS-1 304 and MBS-2 305, are configured to concurrently transmit. In one embodiment, MTCH 351 and 352 are one MTCH with different RBs carrying corresponding MBSs. At step 353, the packet streams for different MBSs are combined. At step 354, the precoding matrix for the next transmission is calculated using singular value decomposition. Then, at step 355, the OFDM signal is generated.

In one embodiment, the concurrent layer-based transmission is conducted between unicast service 306 and the one or more MBS services, such as MBS-1 304 and MBS-2 305. The unicast service 306 is transmitted on a unicast channel 361. In this case, a core layer, with high power and low MCS, is used to deliver the MBS service(s), and the enhancement layer, with low power and high MCS, is used to deliver the unicast service to a specific user. In this case, different users may decode different services. For example, some users that are only interested in MBS service just receive the core layer. The unicast user only receives the enhancement layer to receive the unicast service.

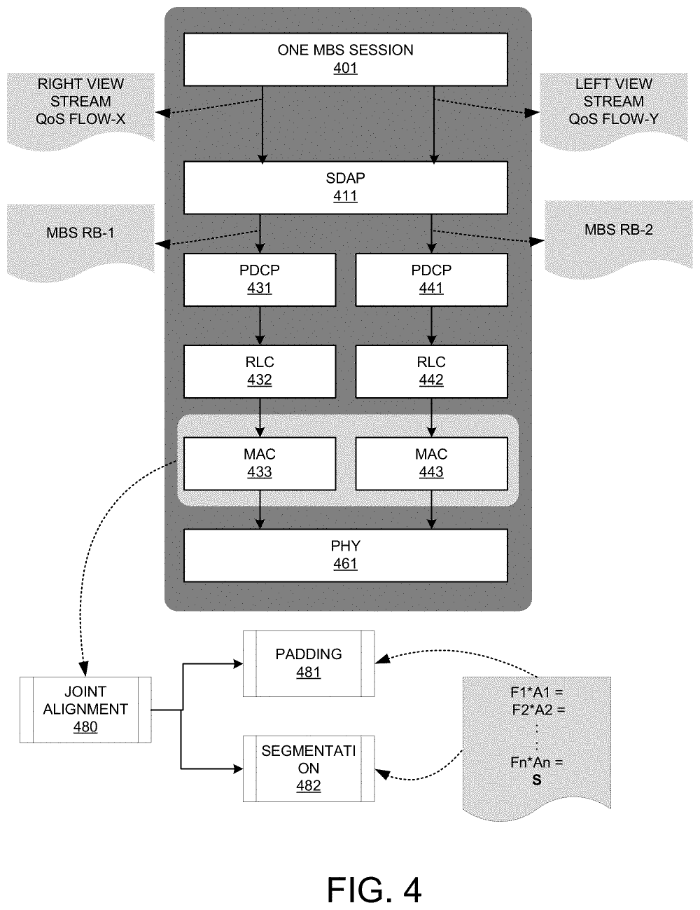

FIG. 4 illustrates exemplary diagrams of the protocol stack to allocate and process multiple independent MBS RBs with corresponding protocol stack entities to support the concurrent MBSs transmission. One MBS session 401 is processed by the protocol stack. The SDAP layer 411 of high layer protocol stack at network side allocates two independent MBS Radio Bearers (i.e., MBS RB-1 and MBS RB-2) with independent PDCP entities PDCP 431 and 441, and independent RCL entities RLC 432 and RLC 442, respectively. In one example, the packet stream for the MBS is split between the QoS flow-X and QoS flow-Y, corresponding to a right view and a left view of the same MBS session respectively. Special handling required at MAC layer of the network side, with MAC entity 433 and 443, to avoid multiplexing data coming from QoS flow-X together with data coming from QoS flow-Y, even though both packet streams are serving the same MBS session or serving the same MBS services. The aim is to produce two consistent MAC PDUs, each corresponding to an independent transport block that is transmitted by a superposition layer at physical layer 461 (e.g., core layer or enhancement layer).

In one embodiment, the joint (data/bit) alignment 480 is performed. A MAC padding 481 and/or a segmentation 482 may be performed for each packet streams. The data flows of core layer transmitting right view and enhancement layer transmitting left view are independently configured, the joint bit alignment 480 is needed, which puts a restriction on the size of the two transport blocks. In order to achieve concurrent transmission of the packet streams coming from QoS flow-X and QoS flow-Y, MAC padding 481 may be used to meet the transport block (TB) size required by physical layer. For example, if QoS flow-X (representing right view) has not sufficient bits to transmit, MAC padding is adopted to produce the corresponding bit size before generating the MAC PDU for core layer. Typically, the core layer and enhancement layer adopted different modulation and coding scheme (MCS) and the enhancement layer can carry more bits than core layer. Accordingly, the packet stream of left view, which is UHD, has more bits to transmit than the packet stream of right view, which is HD. In reality it may not match that well. For example, if the enhancement layer has A bits to transmit for one video frame but the corresponding PDSCH can carry B bits, where A<B. The amount of (B-A) MAC padding bits are used at the MAC PDU before generating the Transport Block. The same principle can apply to core layer.

From superposition transmission perspective, there is a requirement for the bit alignment between core layer and enhancement layer. For example, assuming the transmission bits for one superposition transmission interval is S, and assuming that there is a factor of MCS for core layer and enhancement layer are F1 and F2 respectively, and assuming that the desired size of the transport blocks for core layer and enhancement layer are A1 and A2 respectively, then F1*A1=F2*A2=S. Similarly, for multiple packet streams F1*A1=F2*A2= . . . =Fn*An=S. If for a particular video frame, the MAC PDU of the core layer and enhancement layer is less than A1 and A2, one transport block for each layer should be used for such superposition transmission, each with different amount of MAC padding. If for a particular video frame, the MAC PDU of the core layer and enhancement layer is larger than A1 and A2, two or more transport blocks should be used for such superposition transmission. If for a particular video frame, one layer's MAC PDU cannot be transmitted by one transport block but the other one can be transmitted by one transport block, multiple transmission interval based superposition transmission should be used. In this case, other than the first superposition transmission, the layer that has a small MAC PDU may use a full MAC padding bits to assist the superposition transmission.

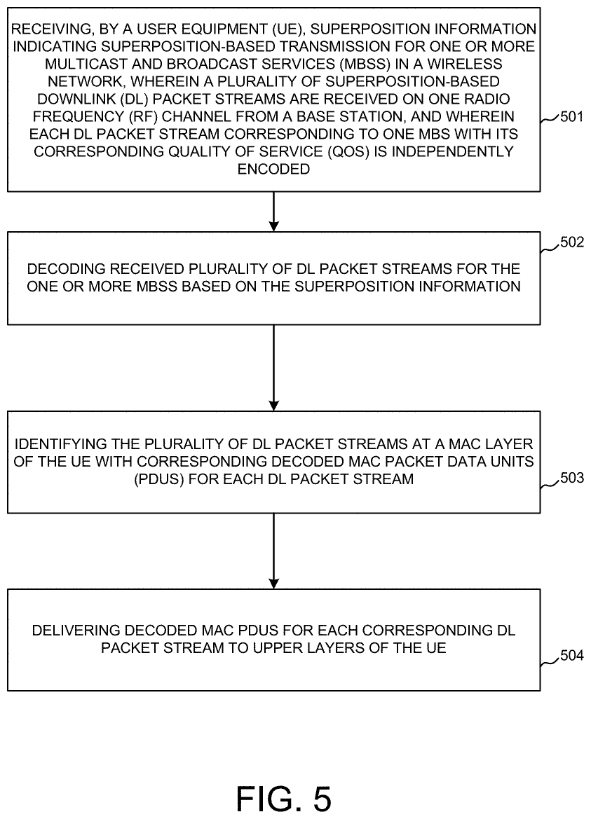

FIG. 5 illustrates an exemplary flow chart of UE for the concurrent transmission of multiple packet streams for MBSs. At step 501, the UE receives superposition information indicating superposition-based transmission for one or more multicast and broadcast services (MBSs) in a wireless network, wherein a plurality of superposition-based downlink (DL) packet streams are received on one radio frequency (RF) channel from a base station, and wherein each DL packet stream corresponding to one MBS with its corresponding quality of service (QoS) is independently encoded. At step 502, the UE decodes received plurality of DL packet streams for the one or more MBSs based on the superposition information. At step 503, the UE identifies a plurality of DL packet streams at a MAC layer of the UE with corresponding decoded MAC packet data units (PDUs) for each DL packet stream. At step 504, the UE delivers decoded MAC PDUs for each corresponding DL packet stream to upper layers of the UE.

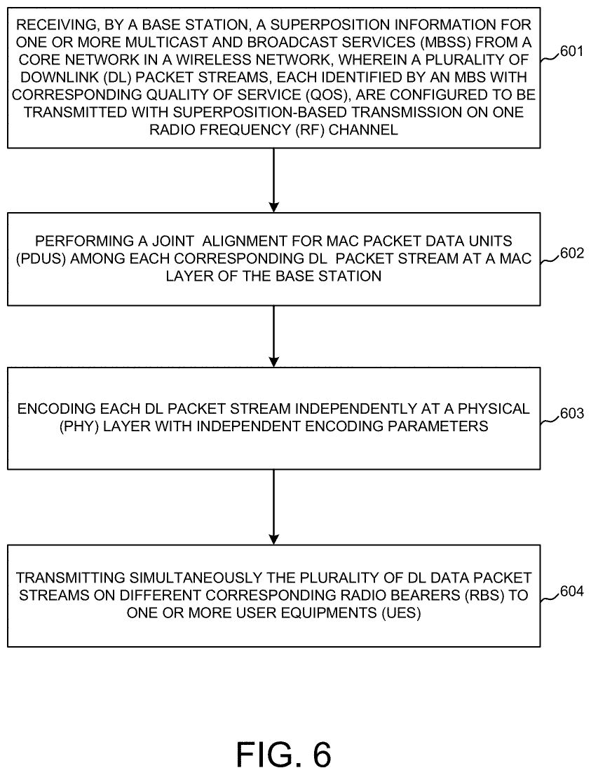

FIG. 6 illustrates an exemplary flow chart of base station for the concurrent transmission of multiple packet streams for MBSs. At step 601, the base station receives a superposition information for one or more multicast and broadcast services (MBSs) from a core network in a wireless network, wherein a plurality of downlink (DL) packet streams, each identified by an MBS with corresponding quality of service (QoS), are configured to be transmitted with superposition-based transmission on one radio frequency (RF) channel. At step 602, the base station performs a joint alignment for MAC packet data units (PDUs) among each corresponding DL packet stream at a MAC layer of the base station. At step 603, the base station encodes each DL packet stream independently at a physical (PHY) layer with independent encoding parameters. At step 604, the base station transmits simultaneously the plurality of DL packet streams on different corresponding radio bearers (RBs) to one or more user equipments (UEs).

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving, by a user equipment (UE), superposition information indicating superposition-based transmission for one or more multicast and broadcast services (MBSs) in a wireless network, wherein a plurality of superposition-based downlink (DL) packet streams are received on one radio frequency (RF) channel from a base station, and wherein each DL packet stream corresponding to one MBS with its corresponding quality of service (QoS) is independently encoded;
decoding received plurality of DL packet streams for the one or more MBSs based on the superposition information;
identifying the plurality of DL packet streams at a MAC layer of the UE with corresponding decoded MAC packet data units (PDUs) for each DL packet stream; and
delivering decoded MAC PDUs for each corresponding DL packet stream to upper layers of the UE.

2. The method of claim 1, wherein the superposition information is received from a RRCReconfiguration message, a MAC control element (CE), or a layer-1 (L1) signaling.

3. The method of claim 1, wherein the plurality of DL packet streams are for a same MBS with different QoS, and wherein the UE combines the plurality of DL packet streams at a service data adaptation protocol (SDAP) layer.

4. The method of claim 3, wherein a first DL packet stream of the plurality of DL packet streams is a core layer packet stream and a second DL packet stream of the plurality of DL packet streams is an enhancement layer packet stream.

5. The method of claim 1, wherein the plurality of DL packet streams further include one or more DL unicast service packet streams.

6. The method of claim 5, wherein a first DL packet stream of the plurality of DL packet streams is transmitted on a multicast RB and a second DL packet stream of the plurality of DL packet streams is transmitted on a unicast RB.

7. The method of claim 1, wherein superposition information further comprises a MAC padding indication to inform the UE of an amount of MAC padding bits for corresponding DL packet stream.

8. A method comprising:
receiving, by a base station, a superposition information for one or more multicast and broadcast services (MBSs) from a core network in a wireless network, wherein a plurality of downlink (DL) packet streams, each identified by an MBS with corresponding quality of service (QoS), are configured to be transmitted with superposition-based transmission on one radio frequency (RF) channel;
performing a joint alignment for MAC packet data units (PDUs) among each corresponding DL packet stream at a MAC layer of the base station;
encoding each DL packet stream independently at a physical (PHY) layer with independent encoding parameters; and
transmitting simultaneously the plurality of DL packet streams on different corresponding radio bearers (RBs) to one or more user equipments (UEs).

9. The method of claim 8, wherein each DL packet stream includes corresponding superposition information indicating the DL packet stream is subject to superposition transmission and its associated DL data packet.

10. The method of claim 8, wherein the superposition information is received by the base station with association information of all the DL data packets for superposition transmission.

11. The method of claim 9, wherein the base station allocates independent radio bearers (RBs) for each DL packet stream at a service data adaptation protocol (SDAP) layer.

12. The method of claim 11, wherein independent packet data convergence protocol (PDCP) layers are established for each corresponding independent RBs.

13. The method of claim 8, wherein the joint alignment involves one or more MAC PDUs operations including MAC padding based on transport block (TB) size required by the PHY layer and segmentation based on TB size required by the PHY layer.

14. The method of claim 8, wherein joint alignment is based on modulation and coding scheme (MCS) factors for each DL packet stream, desired TB size for each DL packet stream, and transmission interval of the DL packet streams.

15. The method of claim 8, further comprising: transmitting the superposition information indicating superposition-based transmission for the one or more MBSs to the one or more UEs.

16. The method of claim 15, wherein the superposition information is transmitted with a RRCReconfiguration message, a MAC control element (CE), or a layer-1 (L1) signaling.

17. A user equipment (UE), comprising:
a transceiver that transmits and receives radio frequency (RF) signal in a wireless network;
a superposition module that receives superposition information indicating superposition-based transmission for one or more multicast and broadcast services (MBSs), wherein a plurality of superposition-based downlink (DL) packet streams are received on one radio frequency (RF) channel from a base station, and wherein each DL packet stream corresponding to one MBS with its corresponding quality of service (QoS) is independently encoded;
a DL decoder that decodes received plurality of DL packet streams for the one or more MBSs based on the superposition information;
a DL packet stream module that identifies the plurality of DL packet streams at a MAC layer of the UE with corresponding decoded MAC packet data units (PDUs) for each DL packet stream; and
a delivery module that delivers decoded MAC PDUs for each corresponding DL packet stream to upper layers of the UE.

18. The UE of claim 17, wherein the superposition information is received from a RRCReconfiguration message, a MAC control element (CE), or a layer-1 (L1) signaling.

19. The UE of claim 17, wherein the plurality of DL packet streams are for a same MBS with different QoS, and wherein the UE combines the plurality of data packet streams at a service data adaptation protocol (SDAP) layer.

20. The UE of claim 17, wherein superposition information further comprises a MAC padding indication to inform the UE of an amount of MAC padding bits for corresponding DL packet stream.
